(19) United States
(12) Patent Application Publication
(10) Pub. No.: US 2019/0340695 A1
(43) Pub. Date: Nov. 7, 2019

(54) DYNAMICALLY COLLECTING AND EVALUATING INFORMATION TO IDENTIFY RISKS ASSOCIATED WITH PROVIDING SPECIFIC SERVICES, SUCH AS INSURANCE COVERAGE

(71) Applicant: Michael J. Bruns, Austin, TX (US)

(72) Inventor: Michael J. Bruns, Austin, TX (US)

(21) Appl. No.: 16/404,331

(22) Filed: May 6, 2019

Related U.S. Application Data
(60) Provisional application No. 62/666,783, filed on May 4, 2018.

(51) Int. Cl. G06Q 40/08; G06F 16/2455; G06N 5/02

(52) U.S. Cl. CPC G06Q 40/08; G06N 5/02; G06F 16/2455

(57) ABSTRACT

Systems, methods and computer program products for providing an automated investigative process, to dynamically collect and evaluate information that would be undertaken by an expert or knowledgeable person in a given field in order to assess the risk and reward associated with providing customized services or products, such as commercial property and casualty insurance coverage for a person or enterprise. The system and method may be used to identify what information an insurance company underwriter or an insurance agent would need to evaluate a specific commercial enterprise's risk for various property & casualty insurance coverages.

### FIELD OF INVENTION

The present invention generally relates to systems, methods and computer program products for dynamically collecting and evaluating information necessary to identity risks associated with providing specific services and/or products to a person or enterprise or other complex decision-making process. More particularly, the systems, methods and computer program products provide an automated investigative process, to dynamically collect and evaluate information that would be undertaken by an expert or knowledgeable person in a given field in order to assess the risk and reward associated with providing customized services or products, such as commercial property and casualty insurance coverage for a person or enterprise. The system and method may be used to identify what information an insurance company underwriter or an insurance agent would need to evaluate a specific commercial enterprise's risk for various property & casualty insurance coverages. Alongside identifying what type of information is relevant in the abstract, the system and method also collects and/or self-generates the actual relevant data for a specific commercial enterprise, and enhances, formats and presents the collected and system-generated data to improve its usefulness in assessing the risks of providing specific types of insurance coverage to the enterprise. Information can also be organized for automated evaluation. The present invention may be applied to any situation where many or complex criteria are used for evaluation of a decision.

### BACKGROUND OF INVENTION

The insurance industry relies heavily on (and arguably invented) actuarially and statistical analysis of data to identity and assess risks associated with providing insurance coverage. In the past, one of the primary challenges in the insurance industry was gathering the relevant data for a specific risk necessary for insurance underwriters to evaluate the likelihood of a covered loss on that specific risk. This data is referred to as underwriting data, exposure data or risk factors. A collection of this exposure data is referred to in the insurance industry as a “submission”.

A basic example of a risk factor or exposure is how many miles a given vehicle is driven each year. Intuitively, a vehicle that is driven 100,000 miles per year has more opportunities to be involved in an accident than a vehicle driven only 100 miles per year. Unsurprisingly, insurers have found that risk of an accident is indeed statistically correlated with miles driven. They combine mileage with corresponding data on the amount of money paid out for vehicles with a given annual mileage, which gives them an understanding of the dollar value of the risk they incur in insuring each mile driven. Of course, the insurer needs the number of miles driven for that specific vehicle to use that insight to insure a specific vehicle.

However, mileage data is just one point of exposure data for just one form of insurance coverage. For automobile coverage other obvious risk factors are driver records (more speeding tickets reflects increased risk) or the make, model and value of the vehicle (repairing an Aston Martin will likely be more expensive than a 10-year-old Subaru). But there are also less obvious factors like Gross Vehicle Weight (GVW), which are only relevant for a subset of automobile coverage evaluations. The heavier the vehicle, the more likely an accident will be severe because of the greater forces involved. For private passenger vehicles, GVW is not material to the risk, but a knowledgeable insurance agent will ask about GVW for box-trucks or larger vehicles, knowing that the insurer will likely need this information. Vehicles used regularly in close proximity to aircraft is another example of an exposure that is only relevant in certain situations.

In the past, the insurance industry has used a top-down model to collect the exposure data needed for a submission for underwriting. Generally, this information is collected via specific forms” one for light vehicles; one for heavy vehicles; and another for companies with airport operations. In such a top-down model, one or more lines of inquiry must be set out in advance. In other words, you have to know what you're looking for before you start. Alternatively, a line of inquiry can contain conditional statements, but each true/false conditional doubles the complexity of the remaining inquiry when using a traditional decision tree model. For such a top-down system, the logic of the system queries that need to be included in the model becomes exponentially more complex, brittle and difficult to follow the more data points and decisions that are included in the model.

The top-down model becomes even more complicated and error-prone when you consider broadly-worded insurance coverages like General Liability, which defends and indemnifies an insured for ‘any bodily injury or property damage’ they cause to a third-party. Depending on the specific operations of a business, the variety of exposure factors to address is almost limitless. If the insured is a restaurant, they are most likely to injure a third party by serving contaminated food or allergens. If they serve alcohol, their greatest risk changes actuarially from contaminated food to being sued for overserving a patron who gets into an alcohol-related accident and injures someone else.

In contrast to restaurants, a furniture manufacturer's primary risk driver is defective products, such as a chair breaking when someone is sitting on it. If they manufacture products marketed to children the risk increases because children are more fragile and more prone to climb on furniture, which can fall on the children and injure them. Without detailed, advance knowledge of a businesses' specific operations a subject matter expert cannot accurately predict what risk questionnaires are appropriate. This escalating, thicket of risk factors becomes denser and indecipherable when you consider entities that combine risks from multiple industries (for example, Swedish furniture makers that are famous for meatballs at in-store restaurants) or from additional coverages like Property, Cyber Liability, Directors and Officers, Professional Liability, and others.

To properly and accurately insure a business, one must accurately identify what risk factors are specifically relevant to that particular business, as well as collect the information needed to evaluate all the risk factors relevant to that particular business. Currently, this is a manual process where an insurance agent first sends general-purpose questionnaires to their clients or prospective clients. By nature, these questionnaires do not address all the risk factors because they are just the first step in a recursive, multi-step line of inquiry—you cannot know a priori what questions will be relevant because some questions are based upon answers collected earlier. Based on the general information collected using the initial questionnaire, the insurance agent must follow up multiple times with more specific applications, surveys or questionnaires, normally in paper or pdf format. These applications can infuriate and frustrate clients because they
1) use industry-specific terms that clients don't understand,
2) request information that the client does not think relevant and therefore does not provide a response o,
3) often require duplicating the same information on multiple documents, and
4) often uncover additional risk factors that the agent then must address, which begins yet another round of clarifying applications.

Currently, the only partial resolution to this frustrating problem is for the insurance agent to make himself personally available to the client to go through everything together, either via lengthy email exchanges, on the phone or in person. The agent depends on their subjective expertise and experience to predict what exposure information may be relevant. This is a huge time expenditure for the agent, and such agents often find themselves repeating the same information gathering process with client after client, rather than performing higher value services like negotiating with insurance companies on their client's behalf.

### BRIEF DESCRIPTION

In the various embodiments, the systems, methods and computer program products of the present invention provide an automated investigative process for dynamically collecting and evaluating information necessary to identity risks associated with providing specific or customized services and/or products to a person or enterprise such as insurance coverage, or to conduct other complex decision-making. Alongside identifying what type of information is relevant, the system and method also collects and/or self-generates the actual relevant data for a specific commercial enterprise, and enhances, formats and presents the collected and system-generated data in various displays, formats or outputs to improve its usefulness. In particular, the line of inquiry of the process implemented by the system and method, which can be considered implemented as a directed acyclic graph (DAG), is created ‘on-the-fly’, such that each question or decision in the line of inquiry encapsulates appropriate instructions or rules as meta data that trigger later questions or decisions that further the investigation. The encapsulation enables the line of inquiry to be easily incrementally improved or adjusted to new factual situations by simply adding or amending meta data with consistent and relatively-simple internal instructions. The answers to each question may ‘beg’ subsequent questions or decisions, or make certain questions moot and therefore unnecessary.

The system and method of the present invention is particularly adapted to collecting information, self-generating additional information from the collected information, and assessing the risks associated with providing commercial property and casualty insurance.

The systems and methods provide multiple advantages over the traditional systems and methods used in the past. In particular, they permit an individual or enterprise user to evaluate their own risk situation the way that a subject matter expert in the field would. Alternatively, a subject matter expert in a field can provide access to the automated system and method to a client in order to speed the data gathering and formatting/reporting process, thereby allowing a subject matter expert to focus time and attention on evaluating the collected and self-generated information, consulting with the enterprise being evaluated, negotiating for services on behalf of the client , automated evaluation of the information, or other use of the collected and self-generated information. In turn, this is a material improvement to common practice in the insurance industry by allowing a subject matter expert to satisfactorily provide services to a larger number of clients in the same amount of time, thereby increasing revenue. The expert may also be able to provide services to smaller or lower-revenue-margin clients that in the past may not have generated enough revenue to traditionally justify the time or expense of the subject matter expert, but now can benefit from those services because of the automated process.

The present invention also reduces the time the subject matter expert needs to spend in maintaining or configuring the system or method for potential users, no matter how varied their needs. Unlike the prior art method of evaluating multiple sequences of questionnaires or specialized application, this present invention simply requires the agent to provide access and the agent, insurance company or subject matter expert's work is done until they receive the completed, formatted information from the system of the present invention.

### BRIEF DESCRIPTION OF DRAWINGS

To better understand this present invention and its advantages, reference is hereby made to the following descriptions of the accompanying drawings:

FIG. 1a depicts a block diagram illustration of an exemplary computer system within which various aspects of the invention can be implemented according to one or more of the embodiments.

FIG. 1b depicts a diagram of a computer-implemented system illustrating the variety of user inputs through typical communication networks and the top-level software application and database modules for implementing various aspects of the system and method.

FIG. 2 depicts a high-level diagram of illustrative host systems connected via a communication network such as the internet or an intranet system, or locally on a single computer or a directly connected set of computer systems, suitable for implementing the methods of the present invention.

FIG. 3 depicts a top-level process diagram of a method of implementing the present invention, implemented on a computer system or collection of networked computer systems.

FIG. 4 depicts a process flow diagram for initializing the system and how the system responds to various initial inputs in order to establish the initial state of the system. This is normally achieved with a URL link but could be achieved with an entry screen on a localized system. Specifically, the required input varies depending on whether the URL in the link or the fields completed in the entry screen include flags for the appropriate agent and/or a sessionId identifying a previously submitted or previously saved submission.

FIG. 5a depicts a process diagram (the Carousel structure) which describes via example the fundamental progression and creation of the various directed acyclic graphs (DAG)s from question reference objects (qrefs) and their encapsulated logical rules, which allow for the organic line of inquiry. Boxes indicate the various carousels, while boxes with a corner removed indicate qrefs that mutate or amend the carousels. This concept is fundamental to the present invention.

FIG. 5b shows how a somewhat simplified version of the example in FIG. 5a would be implemented using a traditional decision tree, and how complex and unwieldy the traditional decision tree method is compared to the present invention.

FIG. 6 shows two example display user interface screens that are representative of 75% of the user's interaction with the system. The screen images are accompanied by corresponding diagrams of the Question Carousel, which corresponds to the primary DAG of the system. The screens and diagrams show a progression of how the carousel is amended and the system responds to an organic line of inquiry from a user interface perspective. In applications where inputs are provided via sensor or other mechanical or electronic input, rather than user input, user screens are not necessary to the method.

FIG. 7 depicts an example screen of a user interface which allows the user to select multiple characteristics that can beg qrefs, schedules or coverages on a wide variety of risk factors. These risk factors overlap and intermix depending on the red flags selected by the user. This figure also depicts 4 inter-related carousels and how they would be affected by the selection of the Technology and Beer/Wine/Liquor Red Flags. In applications where inputs are provided via sensor or other mechanical or electronic input, rather than user input, user screens are not necessary to the method.

FIG. 8 depicts an example user interface display screen where the user selects among several types of insurance policies, of which the menu of policies shown varies based on earlier choices. It also shows an example of a coverage detail screen, where the user completes a miniature version of the system specific to a single coverage, as well as accompanying diagrams showing the Question and Schedule Carousels, as well as an example Coverage Carousel specific to Automobile Liability coverage. Implementing a coverage section is not necessary to the method.

FIG. 9 depicts a process diagram (Schedules) which describes via example how the method can be used to evaluate collections of similar entities within a larger inquiry. The example shows the method being used to evaluate the characteristics of several related real-estate properties, each of which may have different relevant data points depending on its own characteristics and the larger context of the overall inquiry. This diagram shows 4 user interface screens accompanied by diagrams of the relevant qref object and affected carousels that explain how the inquiry is built up.

FIG. 10 depicts a process diagram (Derived Answers) which describes via example how certain facts can be inferred from previously provided data rather than requiring new input from the user or a sensor. In this example, an insurance underwriter needs to know the revenue associated with food sales at a restaurant to evaluate that restaurant for insurance coverage. Instead of requiring that input from a user directly, the answer can be inferred by subtracting revenue from liquor sales and catering revenue from total annual revenue, but only if the risk in question is a restaurant or similar entity. This derived answer, onPremisesFoodRevenue, can in turn be added to the collection of data, with subsequent answers inferred from it in turn. This reduces the absolute amount of data collection necessary from user input or sensors. Derived answers may be used to answer a specific question or address a specific formatting or output need, such as interfacing with another automated decision-making system.

FIG. 11 depicts a process diagram (Forms Creation) which describes how the fully completed submission is used to dynamically create specific pdf forms and applications or other formats, most likely of the type that would traditionally be completed by a subject matter expert conducting a line of inquiry or the user themselves, and by extension formats necessary to interface with one or more automated underwriting systems or other complex decision-making systems. Deciding which forms or applications to create is determined based on the shape and content of the data in the submission via a derived answer. The mapping of answers onto such applications is accomplished via a system of horizontal and vertical coordinates, which allows the data to be overlaid over any background application, as well as a display property that indicates the format in which the answer should be shown. In turn, this allows new forms to be added quickly, or for the system to interface with one or more automated decision-making platforms quickly and easily.

### DETAILED DESCRIPTION OF ILLUSTRATIVE EMBODIMENTS

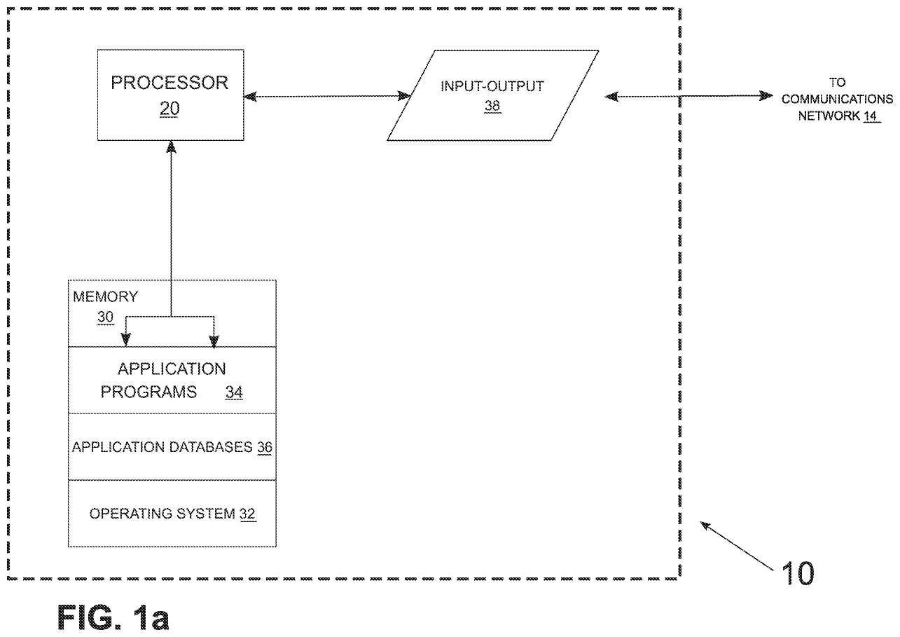

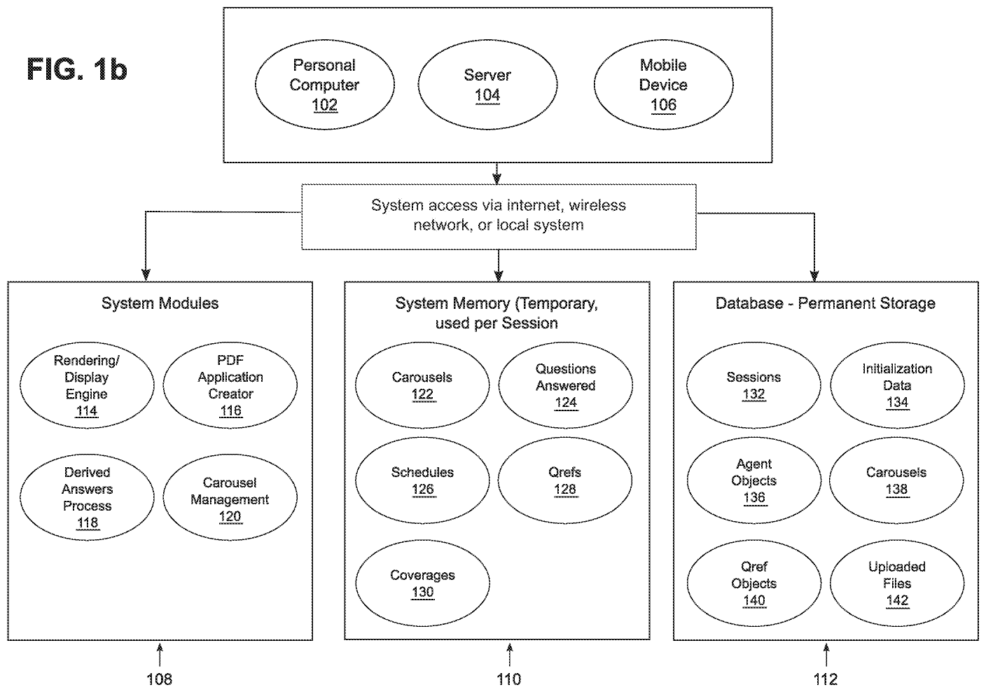

As depicted in FIGS. 1-11, the systems, methods and computer program products for implementing the present invention provide an automated investigative process for dynamically collecting and evaluating information necessary to identity risks associated with providing specific or customize services and/or products to a person or enterprise, such as insurance coverage or to conduct complex decision-making. Alongside identifying what type of information is relevant, the system and method also collects and/or self-generates additional relevant data for a specific commercial enterprise, and enhances, formats and presents the collected and system-generated data in various displays, formats or outputs for consumption by various automated evaluation services to improve its usefulness. The following description of the system, methods, and computer program products is particularly described in the context of implementing the system and method for collecting information, self-generating additional information from the collected information, and assessing the risks associated with providing commercial property and casualty insurance coverage. However, the present invention can be applied to any situation where many or complex criteria are used for the evaluation of a decision.

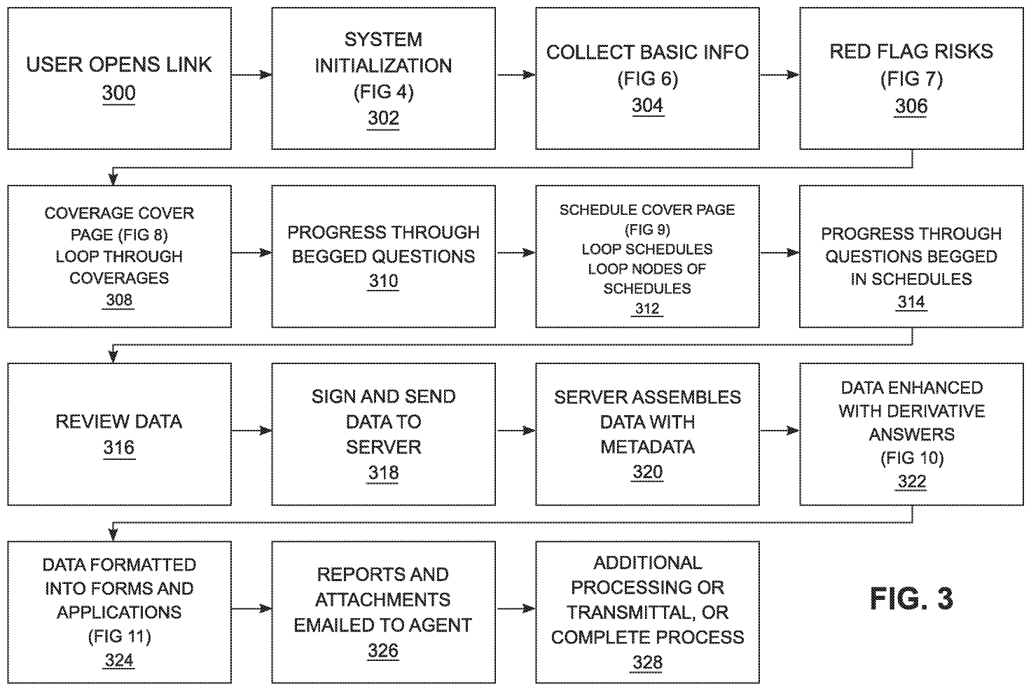

The following terms when used in this document shall have the following meanings:
Directed Acyclic Graph (DAG): a data structure composed of nodes of information and edges or arrows indicating their relationship, similar to a decision tree or flow diagram. A DAG is distinct from a decision tree in that while no node can be a child of itself, multiple parent nodes may lead to the same child node. For the present invention the DAG is the dynamically created structure that arises from processing carousels and qrefs.
Question Reference Object (Qref): A data structure stored as a hash table, Javascript® object or other data structure in electronic memory of a computer system which contains information related to a question being asked to a user or a conditional statement, as well as meta data indicating additional questions (in the form of a qref), schedules, coverages, actions, instructions or decisions that would be appropriate or inappropriate depending on input. Qrefs represent simple conditionals, decisions or rules in the abstract. They are independent of the context of the specific situation in which they are applied. Generally, they are defined in advance of the line of inquiry (as defined below) and, while normally of trivial complexity in themselves, they can describe complex situations when compiled together. A qref is further defined by its ability to be understood simply and in isolation as a specially formatted conditional statement that should be easily understandable by human reviewers.
qBegged: The meta data within a qref that indicates additional questions, schedules, coverages, actions, instructions or decisions that would be appropriate or inappropriate depending on how the user answers the initial question or otherwise dependent on input. When a user's answer to qref A indicates that another qref B should also be presented to the user, it can be said that that qref A begs qref B. This type of information is stored in the qBegged property of the qref.
qType: The meta data within a qref that indicates the nature or type of the question, schedule, coverage, action, instruction or decision to be presented to the user, such as a true or false question, multiple choice question, text input question, or others. This information is used to render or otherwise apply the qref intelligibly; can be relevant regarding how the answer is stored; and can affect the structure of the qBegged property of the qref.
Line of Inquiry: a series of questions asked or actions to take with the intention of understanding a complex object or situation or executing a complex task, asked or executed by a subject matter expert or approximating what a subject matter expert would ask or execute, if they were present. An example of a line of inquiry would be a paper wedding invitation asking whether a guest is attending; whether there are bringing their spouse; and whether they prefer the chicken, pork or fish for their dinner. The questions or other conditionals and the order in which they are addressed are normally set in advance rather than dynamically adjusted depend on the answers to early questions.
Organic Line of Inquiry: a line of inquiry that is adjusted as questions are answered or new input is otherwise generated. An example would be a police officer filing a report on a car accident, where they ask a driver whether they had been drinking. If the driver answers yes, the officer asks additional questions about how much and where. If no, those questions are not asked, and the officer proceeds with questions applicable to all accidents such as the speed limit, where the driver has been recently, general description, names of witnesses, etc. The officer may be prompted to ask whether a driver can walk along a straight line by either a yes answer to whether the driver was drinking, or if the driver says they have been at a bar when asked about where they've been recently.
Carousel: A data structure in electronic memory of a computer system stored as a list of objects, normally qrefs, to be presented to the user or to process other input, which can be dynamically updated by adding or removing objects, normally qrefs, so as to direct the remaining course of the organic line of inquiry, including identifying qrefs or other objects prohibited from being displayed or considered which is called a Nonsense Carousel. Carousels are updated by comparing the current state of the system (which may include multiple carousels and other stored data) with the qBegged property of each qref that is processed. See the explanation of FIG. 3 for more details.
Red Flags: activities, operations, characteristics or other properties that may define a user or their operations which an experienced subject matter expert would identify as a trigger to pursue a more in-depth line of inquiry.
Risk: the chance of a negative outcome or loss. This term can also refer to a specific or representative person, organization, business or asset or liability thereof being considered for insurance and the chance of negative outcome or loss specific to that person, organization, business or asset or liability thereof. This definition reflects the common use of the term in the insurance industry.
Exposure: a hazard, condition or characteristic of a risk that exposes the risk to loss. This definition reflects the common use of the term in the insurance industry.

A system is provided 10 by which risk factors or other complex decision-making can be addressed individually as questions or conditional statements (qrefs) with understandable encapsulated rules that are limited to a single step of the inquiry. These qrefs self-assemble into a flexible organic line of inquiry that allows for proper underwriting of any combination of risk factors, all in a single session without requiring later follow ups.

The system and method also address the issue of annual renewals or updates of information that can develop over time or be changed periodically, such as commercial insurance policies. Because such policies are technically stand-alone contracts, they require the full payload of information to be refreshed annually, even though many risk factors remain largely the same year-by-year. Because the system 10 retains that data in a flexible and simple machine-readable format, it allows the user to return to the system 10 periodically and begin with their information from the previous year already completed, rather than a blank slate, and simply be guided to update information that is likely to have changed. This dramatically speeds the periodic review and update of information (such as renewing insurance policies) as well as encouraging the user to continue to use any services dependent on the system so that they do not have to go through the entire process again.

While the above paragraphs describe commercial insurance, this invention can also be used in any situation where a user or customer would consult an expert and the expert would follow a line of inquiry or any complex decision-making system. Other examples include, but are not limited to
1) medical diagnosis to evaluate care plans,
2) legal analysis based on case law and legal tests,
3) identifying regulatory and compliance factors across multiple or overlapping jurisdictions and authorities to develop compliance plans, and
4) collecting project goals and assembling a project development plan and needed materials.

In the following detailed description of illustrative embodiments of the system and method, specific embodiments in which the invention may be practiced are described in sufficient detail to enable those skilled in the art to practice the disclosed embodiments. It is also to be understood that other embodiments may be utilized, and that logical, architectural, programmatic, mechanical, electrical and other changes may be made without departing from the general scope of the disclosure. The following detailed description is, therefore, not to be taken in a limiting sense, and the scope of the present invention is defined by the appended claims and equivalents thereof.

### FIG. 1a: Example Hosting Systems and FIG. 1b: Top Level Application Modules

FIG. 1a illustrates a typical hardware configuration of a computer processing system (dashed box 10) which is representative of a hardware environment for practicing the present invention. Referring to FIG. 1a, computer system 10 may have a processor 20 coupled to various other components. A computer operating system 32, such as a Microsoft Windows® or a Linux® operating system, may run on processor 20 and control and coordinate the functions of the various components of FIG. 1a. Application programs 34 stored in memory 30 and coupled to various application databases 36 may run in conjunction with operating system 32 and provide calls to the operating system 32 where the calls implement the various functions or services to be performed by application programs 34. Applications may be further broken down into program modules. Application programs 34 include, for example, the modules as described in more detail below in association with FIG. 1b. It should be noted that software components, including operating system 32 and the application programs 34 of the present invention, may be loaded into the processing system's main memory 30 for execution.

FIG. 1b shows some of the main application and database modules of the system. The method of the present invention may be implemented through a “software as a service” model, wherein the computer system 10 in FIG. 1a may be a server or other computer system located or “hosted” in a data center 104 or in an subject matter expert's office that may be accessed from a personal computer 102, a mobile device 106 such as a cellular telephone, or other user-interface device. Any of these three options could be considered client devices. Client devices can access the system 10 in FIG. 1a via the internet, a cellular telephone network, a local area network, any other wired or wireless communications network. Alternately, the system 10 in FIG. 1a can be the client device in which case the various modules would be stored on the client device for local processing rather than network calls to separate devices or modules.

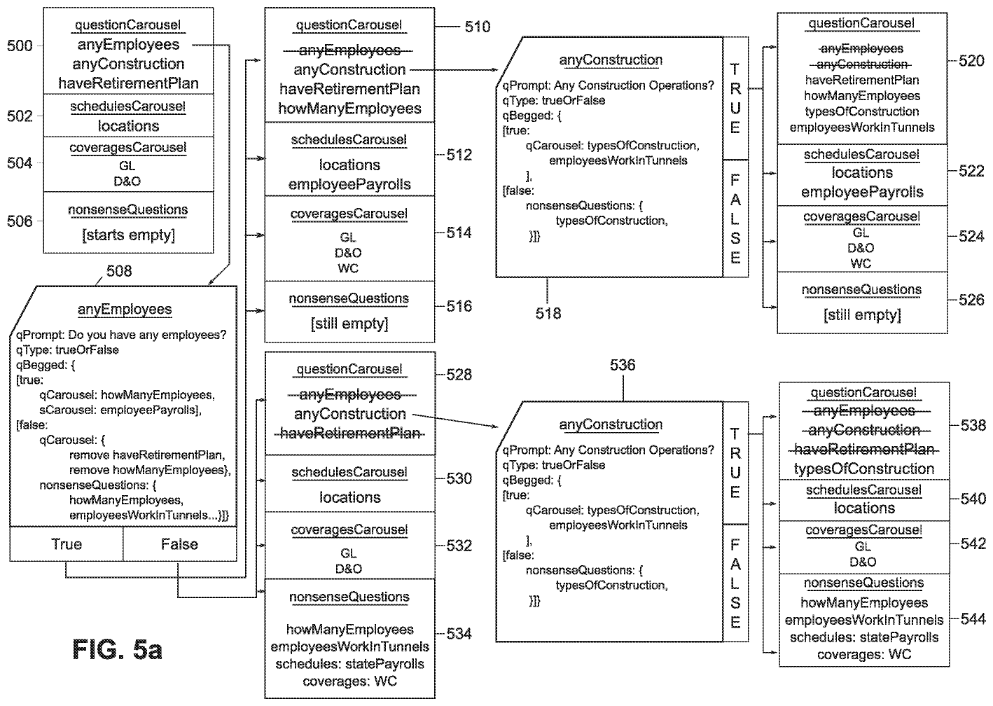

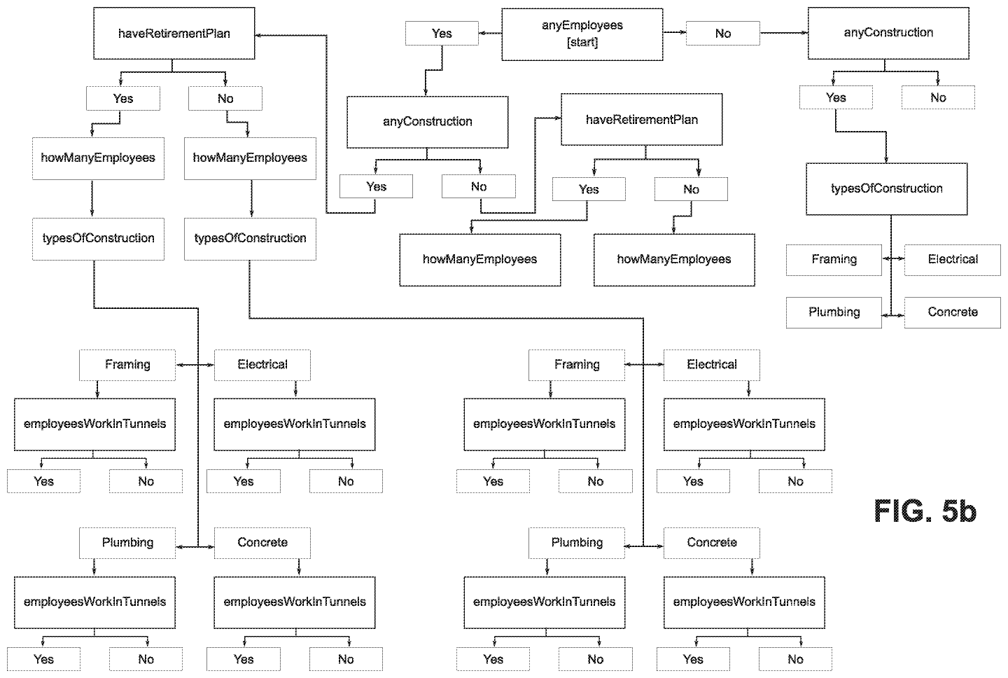

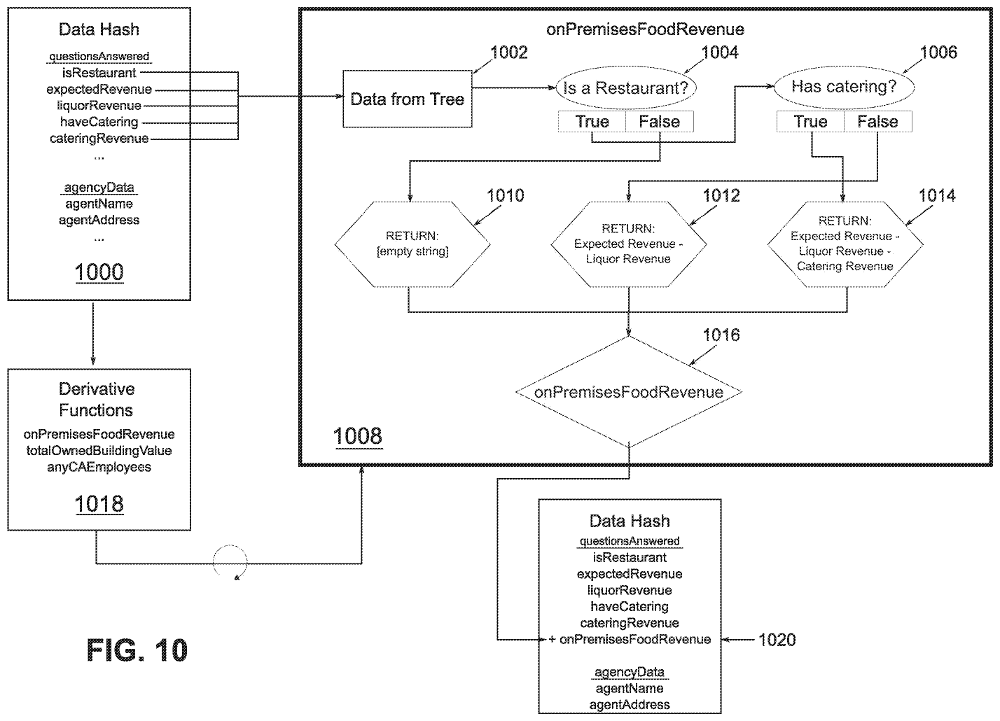

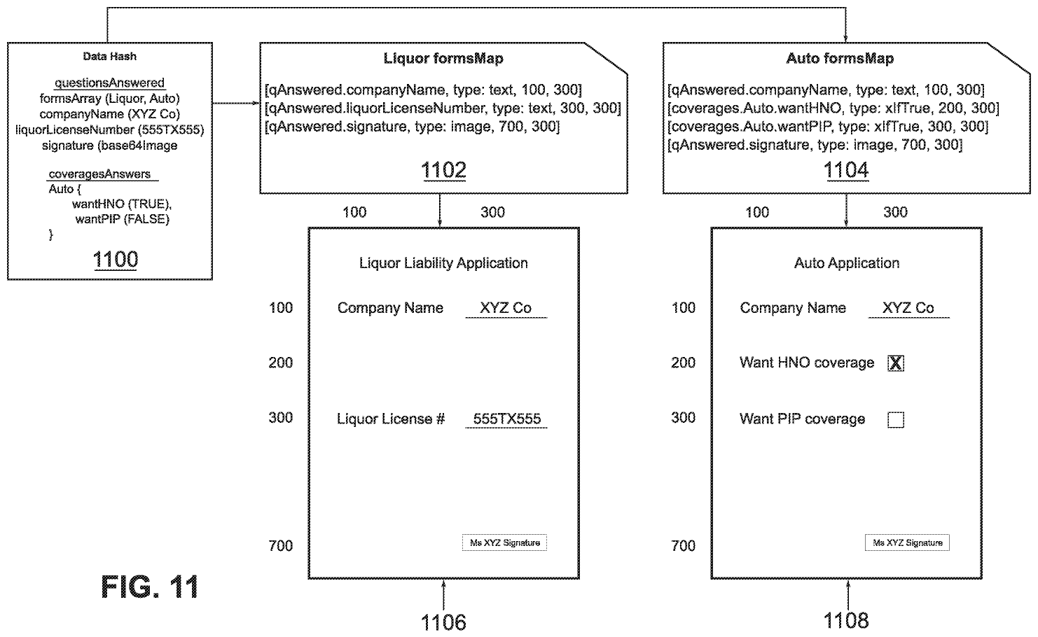

The system itself is comprised of the interplay of several components or modules, both on the client device or on a remote server. System Modules 108 describes the main components that act upon provided data. These include the rendering/display engine 114, which could include an HTML or Javascript® framework in the case of delivery over the internet or an intranet, or any other system that displays data to the user, an outside application program interface (“API”), or any system that evaluates inputs. The PDF Application creator 116 is further described in FIG. 11. The Derived Answer process 118 is described in detail in FIG. 10, and the Carousel system 120 is described in FIG. 5a.

System Memory 110 depicts the databases or data silos that are stored in the temporary memory of the client device regardless of whether the method is implemented over a network. Carousels 122 stores the current state of the various carousels, such as described in FIG. 5a. Questions Answered 124 is a simple hash table or key-value table, such as a Javascript® object or JSON object, with the name of the qref as a key and the answer to a shown qref as the value. Questions Answered could also take the form of an SQL database or any database storage format. Schedules 126 is analogous to Questions Answered 124, except that it stores answers that are related to specific instances of a given schedule (such as answers regarding a specific driver in a list of drivers). Coverages 130 is analogous to Schedules 126, except that is stores answers related to a specific Coverage, such as the limit of insurance for the General Liability coverage. Finally, Qrefs 128 is a simple copy of the collection of qref objects from the database, stored in local temporary memory for fast and easy access by the client device. This is optional, and Qrefs can be downloaded dynamically as needed from permanent storage based on the status of carousels if desirable or necessary to reduce bandwidth usage.

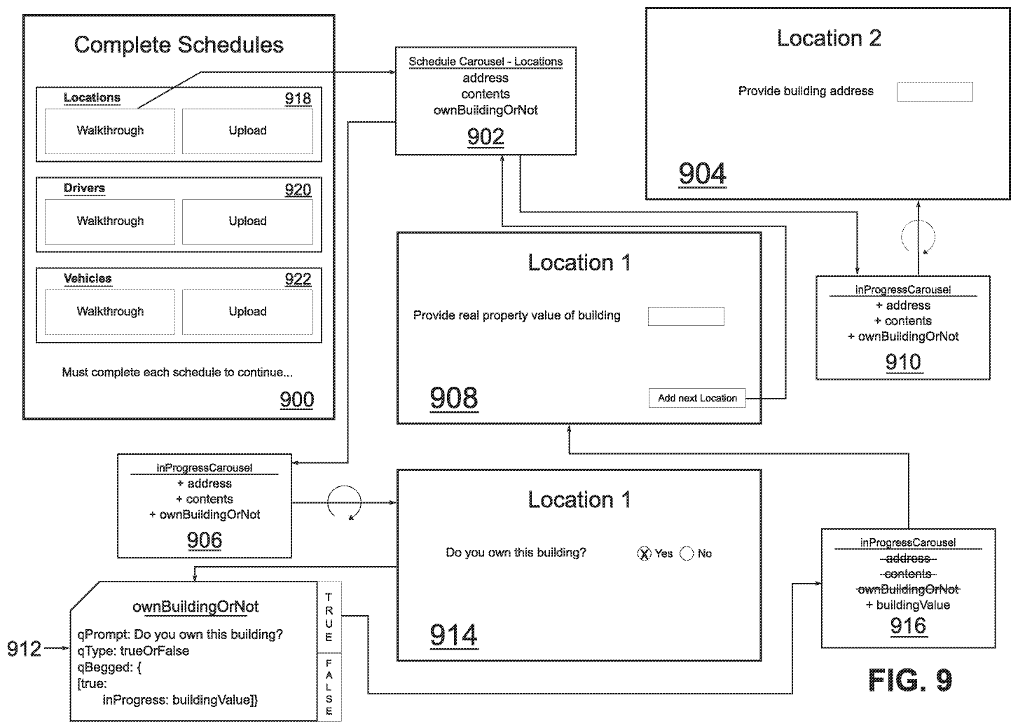

Database—Permanent Storage 112 in FIG. 1b depicts a simple database, either relational or non-relational. If the invention is being hosted on a networked system this may be on a separate computer or may be stored on the hard disk or other permanent storage if the application and databases are hosted locally. The ovals within the database indicate the different document collections or tables that are used for various parts of the system. The Sessions collection 132 stores the data provided by the user and associated meta data, and is used for processing completed submissions, renewing past submissions, or is created for a new submission. The Initialization Data 134 is a collection of various types of data, which is used to initialize the system if a user enters with no previous submission and sets the system components to their default state. Agent Objects 136 is a collection of data that describes various subject matter experts with which a user may be engaged. The Carousels collection 138 is a collection of various carousels that, in combination with the Sessions collection and the Initialization Data collection, set the system components to their default state or a state appropriate to a returning user. The Qref Objects collection 140 is a collection of all possible qrefs, which can be begged by the various carousels. The Uploaded Files 142 collection is a storage area for any files that are uploaded by the user, most commonly uploaded schedules as described in FIG. 9: Schedules Flow Diagram.

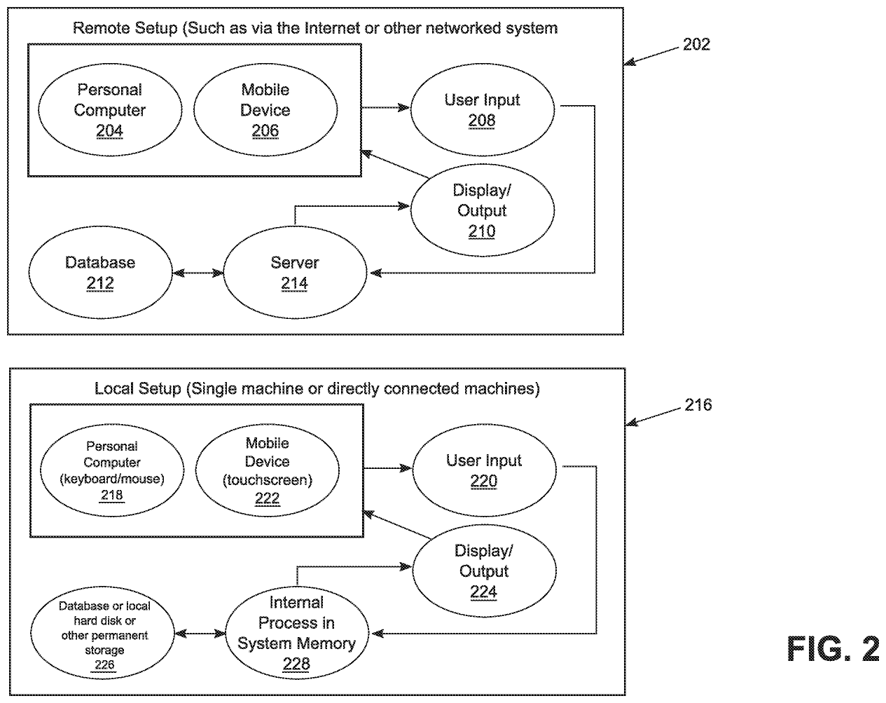

### FIG. 2: Example Hosting Systems

FIG. 2 depicts two potential (but not exclusive) hosting systems for this invention. The upper diagram 202 shows a networked configuration, such as over the interne or an intranet. The user provides input 208 and views displayed output from a personal computer 204, mobile device 206 or programmatically via a server, such as with an API. That data is passed to a server 214 that, after interacting with a database 212 appropriately, processes the input 208 and produces output 210.

The lower diagram shows a local configuration, which is identical to the networked configuration except that the server 214 is replaced with an in-memory subroutine 228 (processed by the same or a parallel processor 20 in FIG. 1a as the input 220 and output/display 224) and the external database 212 is replaced with permanent storage in electronic memory 226 associated with the local system.

### FIG. 3: Top-Level Process

FIG. 3 provides an overview of the step-by-step progression of an illustrative method implementing the invention. All user interface descriptions and interactions throughout this document are not necessary to the method and can be replaced with programmatic directives or direct mechanical or electronic input, such as from sensors or by similar means. The process begins when a user enters the system through a link 300, most likely sent them via e-mail by a subject matter expert but may be via an entry page in a local system. This link connects to a server or local environment, which is loaded with an instance of the system and is connected to various databases which store qrefs, past submissions and other potentially relevant data. Based on the formatting and content of the URL, the system sets up an initial state 302 as a framework in which to receive the information that the user will provide. After initialization and a welcoming explanation, the system identifies an initial set of basic questions that will be relevant to all users and presents these questions to the user as an online form of the type that will be very familiar to any user of the present (circa 2018) internet. The user's answers to these queries will mutate the DAGs by adding or removing qrefs from the various carousels, which determine what information is collected later. This process is explained in detail in FIG. 5a.

After the basic questions are answered, the system shows the ‘Red Flag’ screen 306, which displays characteristics or labels that, if mentioned by the user in conversation or otherwise disclosed, would cause an experienced subject matter expert to pay additional attention and pursue a more detailed line of inquiry. This allows the system to quickly discover and address dramatically disparate risk factors that may not normally be associated with each other and uncover necessary questions/qrefs that could otherwise be overlooked. From there the system moves on to the Coverages Cover Page 308, where a user is presented with a brief description of various key choices. In an insurance context these choices are the relevant insurance coverages. As respects other contexts noted earlier (medical diagnosis, legal analysis, compliance, and project management), these could be choices such as treatment options, jurisdictions in which to file claims, jurisdiction in which compliance is necessary, or project milestones to be completed.

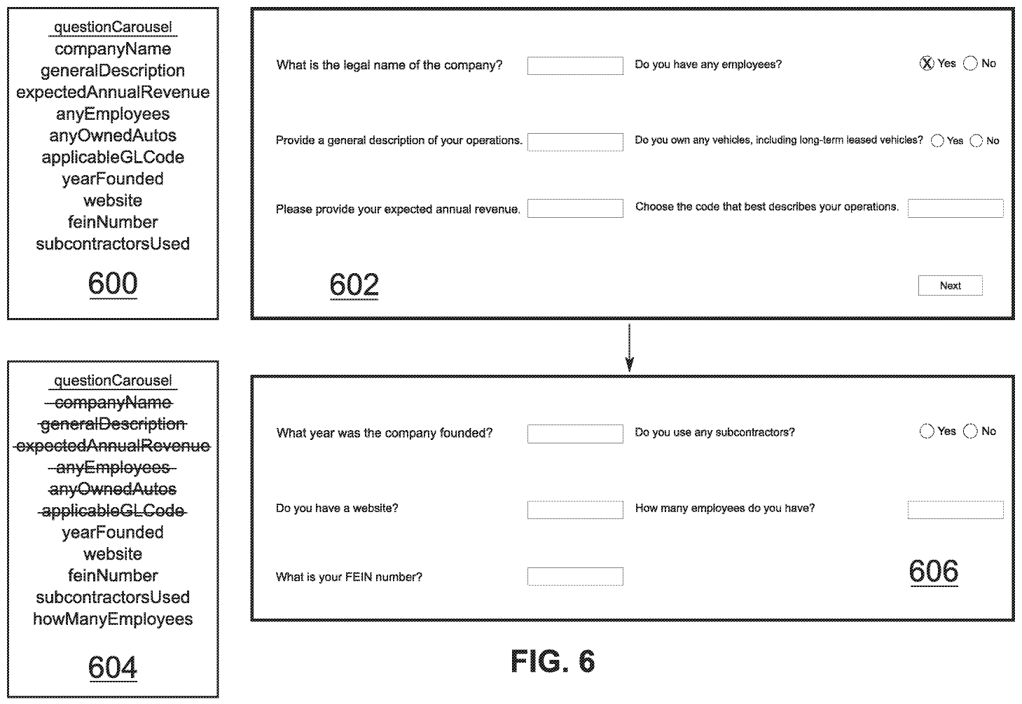

Each coverage, in turn, leads to additional or removed questions/qrefs 310, some of which will be asked directly in relation to the coverage, and some of which are more general and are thus asked in the normal course of the DualColumns screen progressions. This is a progression of screens of the type shown in FIG. 6, with the actual questions populated by the Question Carousel using the process outlined in FIG. 5a.

Once the Question Carousel is empty, the system progresses to the Schedule Cover Page 312 which is described in more detail in FIG. 9. Schedules follow a similar process to Coverages but are unique in that a schedule is essentially a list of items of a related class. As such, they require a baseline carousel (the carousel for the specific schedule) which is used for each new instance, as well as an in-Progress carousel where qrefs specific to an instance can beg additional qrefs related to that specific instance. In some cases, schedules can also be satisfied by the user uploading an existing file that substantially addresses the same subject matter as would be addressed by progressing through the schedule carousel. In an insurance context schedules might be lists of business locations, vehicles or drivers. As respects other contexts noted earlier (medical diagnosis, legal analysis, compliance, and project management), these could be lists of current medications, legal claims that need to be resolved, filing deadlines for regulatory reporting, or different rooms detailed a construction blueprint.

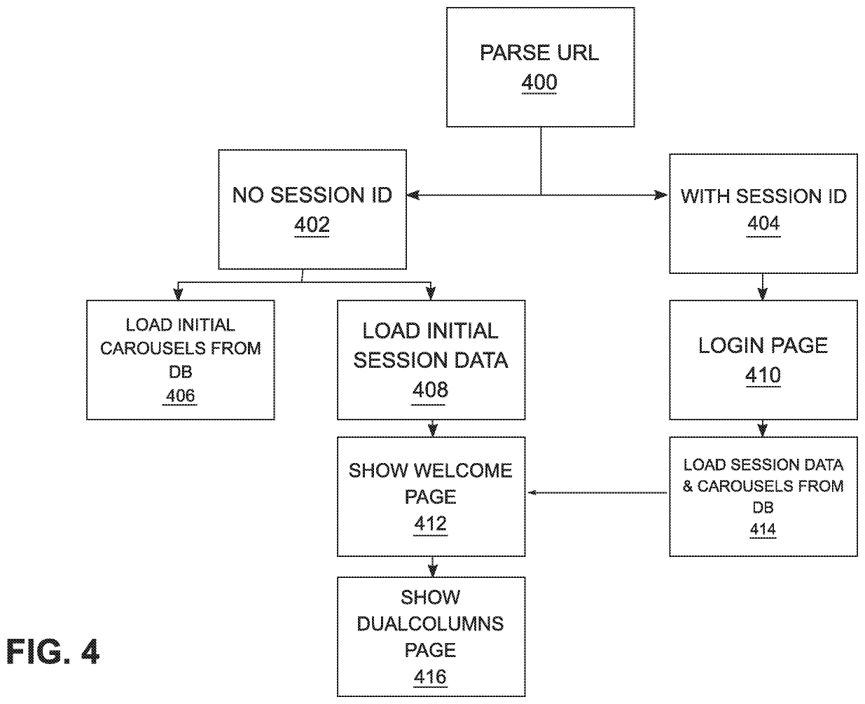

After all schedules are completed, the system does a final check of the Question Carousel to determine if any queries were begged in the course of completing schedules 314. If so, it cycles the DualColumns screen again (FIG. 4) until the Questions carousel is empty. At this point the user has the option, or can be compelled, to review 316 and amend any information that has been entered in the system incorrectly or which, in the case of renewal or update of a previous submission, is no longer accurate. If necessary, after this factual review the user reviews the terms and conditions of the service and confirms their understanding and agreement to those conditions with a digital signature and by clicking a button to submit the submission to be processed 318. At this point the data is packaged appropriately 320 from the client browser and transmitted to the back-end server (or local environment) for storage in a database which may be running locally or on cloud services.

On the server (or local environment) the information is assembled by downloading the submission data from the database, along with additional correlating information including, but not limited to, detailed information regarding the subject matter expert associated with the information, as well as any schedules or other file attachments uploaded by the user or downloaded from third parties. This information is stored in a key-value or hash table such as a Javascript® object (or a string representation thereof) in a manner known by software developers having ordinary skill in the art.

Once the data is assembled on the server (or local environment), it is passed through a series of functions 322 with the goal of deriving additional facts about the submission which can be deduced by combining answers to other questions or by considering the answer to one or more questions from different perspectives. Alternatively, this process can be undertaken dynamically as carousels and qrefs are processed. This process is described in detail via example in FIG. 10, and its purpose is to reduce the number of redundant questions presented to the user, thereby reducing both their cognitive load as well as reducing inconsistent information. As these answers are derived as described herein, they are placed into the submission data in the hash table and can in turn be used to deduce additional answers.

Once all derivative answers have been added to the data hash table the data is ready to be mapped into various formats that are appropriate for the data contained in the submissions 324. This process is described in FIG. 11 and includes both a comprehensive spreadsheet format, an assembly of pdf applications or similar documents, and can include formatting data to more easily interface with automated decision-making systems. These could include (but are not limited to) insurance carrier underwriting systems such as CAN Connect, Agency Management Systems (AMS) such as Applied Epic, Applied TAM, Vertafore Sagitta, Vertafore AMS 360, or similar systems. The specific applications to be created vary based on the data and creating a list of appropriate applications or required interfaces is the responsibility of one of the derived answers functions described in the above paragraph.

Finally, once all spreadsheets and pdf applications have been created on the server (or local environment), a message, such as an email, is sent to the subject matter expert or other designated receiver of the submission as detailed in the submission data 326. In a local environment this message transmittal could be replaced with a local display or similar system. This message or display is sent in a manner common in the software industry, and includes the overview spreadsheet, created pdfs and any schedules uploaded by the client or any file attachments and a record of the message or display is stored in the database. In addition, data can now be used for other purposes, such as transmittal to a third-party database or information system maintained by the subject matter expert or user or to automatic underwriting systems or other uses.

Upon completion, the server or local computer process by which the submission was processed is resolved, and the submission is completed 328.

### FIG. 4: Initialization

FIG. 4 shows how the system adjusts its initialization sequence based upon the URL or other access point provided when a user enters the system. The URL domain provides initial access to the system, and by parsing the URL 400 the system identifies two relevant data points through either URL parameters or query strings: the agentId and the sessionId. The agentId identifies a subject matter expert (such as an insurance agent) or other submission receiver. The agentId must have a corresponding record in the database with information for the subject matter expert to be considered legitimate by the system. If an agentId is not provided or is not legitimate the system will not initialize; the user will receive a warning that the agentId is not valid, and the system will redirect to another website or error screen.

If the agentId is confirmed valid, the system will check for a sessionId encoded in the URL. A sessionId is an identifying code that serves as a serial number referring to previously entered data. This data may be a partially completed submission, or a completed submission that can be updated with new information such as during a renewal.

If the URL does not encode a sessionId 402, or the sessionId is not valid, the system initializes a new submission 408. Basic information regarding the subject matter expert (such as the insurance agency name in an insurance context) is incorporated based on the legitimate agentId. To this, the system adds default initialization carousels 406 downloaded from the database. These default carousels are defined in advance and contain a limited set of qrefs common to all users of the system such as the company name, primary contact and similar universal questions. Once these carousels are loaded, the system user interface displays a welcome page 412 which can be white labeled and branded based on the subject matter expert agentId. When a user clicks the start button the system shows the first DualColumns screen 406 with the basic questions from the default carousel.

If the URL does encode a legitimate sessionId 404 the user is not taken directly to the welcome page, but instead to a login page 410 in which they can enter their username and password which they created when working on the submission previously. If that username and password are correct, the system initializes with the information from the past submission 414, rather than the default information, thus saving the user the time and effort of re-entering previous information. If the sessionId corresponds to an incomplete submission the user will be returned to the screen in which they exited the process. If the sessionId corresponds to a completed submission the system creates a new submission but populates most of the data in it from the previously completed submission, excepting information that is designated to not carry over. In such cases the user is shown an alternate welcoming prompt 412, and the system progresses through a somewhat shorter set of steps that is substantially the same as new submissions, but with fewer questions necessary.

### FIG. 5a: Carousel Structure and FIG. 5b: Classic Decision Tree

FIG. 5a shows by example how the qrefs and carousels work together to dynamically affect what questions/qrefs, schedules and coverages are relevant to the organic line of inquiry and shown to the user. This is fundamental to the present invention and is applicable in any complex decision-making system. The line of organic inquiry presented by the system can be visualized as a DAG and is built dynamically. The root of the DAG is a set of references to questions applicable to all users. The system reads these references and loads the referenced data object from the database or from system memory.

These data objects are called qrefs (508, 518, 536), which is shorthand for question reference objects as defined earlier in this document. Qrefs contain a collection of properties that the system uses to display the question to the user. These properties include, but are not limited to, qPrompt for the specific phrasing of the question; qType to describe whether a question is, for example, true/false, a dropdown menu, a text input or other formats and is used by the system to display the appropriate component; and a qHelp property that is used to show the user helpful information with context and advice for answering the question. Qrefs also contain an important property called qBegged.

The qBegged property is fully encapsulated within the qref and includes meta data instructions necessary to dynamically build the DAG based on the user's answers or other input. These instructions are in the format of a hash table of possible answers to the current qref. In the case of true/false questions there would be a certain set of instructions for true and another set for false. For multiple-choice questions (represented by a dropdown menu), there would be a set of instructions for each of the multiple choices. Similarly, text-input or similar high variability qTypes can prompt subsequent questions based on satisfying certain conditions or by routing the input to a lambda calculus function returning true or false, or other limited set of output options. This would apply to questions such as revenues above a certain threshold, or serial numbers containing a certain sequence of letters.

When a question is answered by the user, the system compares that answer to the instructions in the qBegged property in the corresponding qref. The most common instruction is to show the user another related or clarifying qref or require another decision, but instructions could also indicate to remove a qref, or could involve coverages or schedules that should or should never be displayed. In the terminology of the system, one question can ‘beg’ another question, or ‘beg’ a schedule. This organically creates the line of inquiry as questions are shown and answered.

This process can become very complex, especially because the same later question can be begged by multiple predecessor questions. Often the user just needs to answer questions and does not necessarily need to know what specifically triggered those questions. That being the case, in an insurance context the system drops the DAGs as they are created, and instead uses simple lists called carousels (as defined earlier in this document) to track which questions need to be asked, and simple hash table structures to store the user's answers. When questions are begged, they are added to the appropriate carousel (or removed). To display qrefs, coverages or schedules, the system simply starts at the top of the relevant carousel and renders whatever qref, coverage or schedule is indicated until the carousel is empty.

Of note, it is trivial to create a log file of begged questions and their triggering criteria as they are generated, providing transparency as to why certain questions, actions, instructions, schedules, coverages or decisions or decisions were begged in a specific instance. In a more generalized application where this invention is being used as a framework for evaluating complex data-driven decision-making (for example as an alternative or enhancement to a neural net or deep learning system) this log allows an auditor or subject matter expert to understand exactly how the system arrived at its final decision state. This has major benefits in that the system can be easily and accurately adjusted if it produces incorrect or irrelevant information, an improper decision, or exhibits bias. This is of great benefit over existing neural-nets and machine learning algorithms which are essential “black-box” systems where the decision-making criteria are very difficult to adjust or discern if and when they produce undesirable results. The present invention is a material improvement to identifying and correcting the issue of inherent, unintentional bias in complex decision-making processes.

As qrefs are presented and the answers stored elsewhere, the answered qrefs are removed from the carousel, thereby shortening it. Likewise, qrefs added or removed because of encapsulated logic in prior qrefs can lengthen or shorten the carousel. Like how the classic playground toy continues to spin or slow as children hop on and off, the carousels in this system continue to spin as qrefs push it along and the system is resolved when there are no more questions remaining.

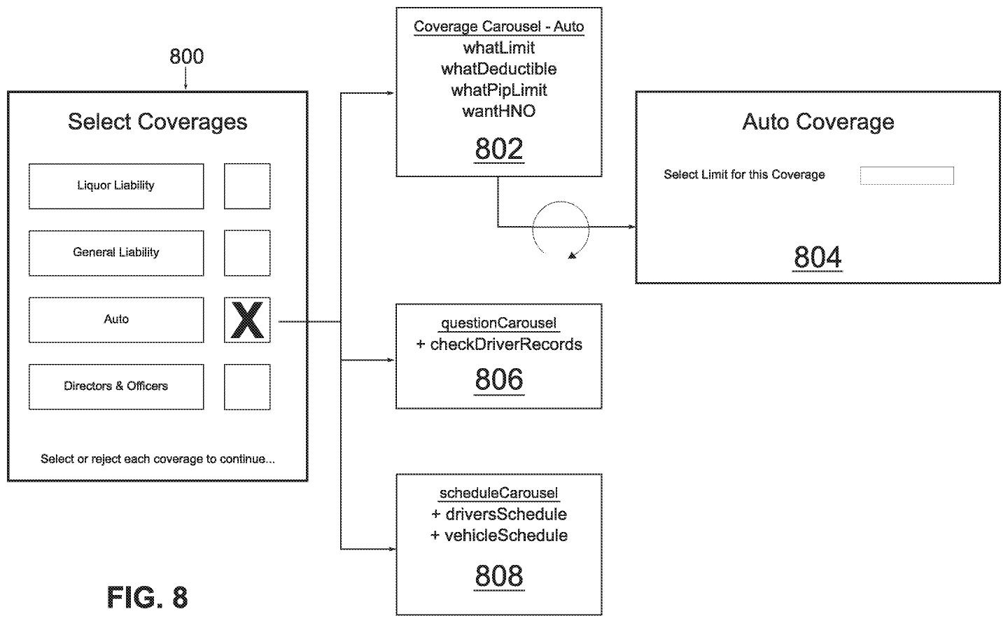

This illustrative embodiment of the system and method uses four primary carousels, as well as numerous sub-carousels corresponding to specific coverages or schedules. There is no limit to the number of carousels that can be incorporated into this method. Possibly the most important carousel is the Question Carousel. At any given point, the Question Carousel contains a list of qrefs that still need to be presented to the user. As the user progresses from screen to screen of the user interface, the carousel may lengthen or shorten, but when it is empty the user is done answering questions on the DualColumns screen. The Coverages Carousel is a list of coverages with which to present the user, and the Schedules Carousel is a list of schedules to present to the user. The in-Progress and ancillary carousels for Coverages and Schedules are described in FIGS. 8 and 9, respectively.

The fourth primary carousel is the Nonsense Carousel, which contains qrefs that become moot in light of the answer to an earlier question. Because they are moot (not merely inapplicable based on current answers) they should be precluded from consideration even if the answer to a qref presented later would normally beg them. In practice, this carousel is a negative cross-reference where any qrefs, actions, instructions, schedules, coverages or decisions that normally would be begged later are prevented from being added to any other carousels.

As an example, the diagram in FIG. 5a shows two layers of branching choices of the DAG as the carousels and qref are processed, starting with a qref asking whether the user has any employees. This diagram shows the logical progression only. The user interface or other input mechanism is not shown. In this diagram each rectangular box represents a carousel and contains the qref, coverages or schedules that are expected to be shown to the user. Boxes with dog-eared corners represent qrefs and show a condensed version of their properties, most important of which is qBegged. The top left corner of the diagram in FIG. 5a shows an initial state of the Question Carousel 500, Schedules Carousel 502, Coverages Carousel 504 and Nonsense Carousel 506. The qref anyEmployees is the first qref on the Question Carousel 500, therefore the system renders the anyEmployees qref 508 for the user to answer.

The anyEmployees qref 508 has a qType of true/false, and therefore displays to the user the question prompt “Do you have any Employees?” along with a binary choice of yes or no, which is shown in the diagram as True or False. At this point the diagram splits into an upper and lower progression. The upper progression shows what happens if the user answers yes (indicating they do have employees), while the lower part of the diagram shows the progression for a no answer.

Focusing first on the yes answer (upper progression), the Question Carousel has been amended to remove the qref anyEmployees 510. This is because anyEmployees has already been asked, and therefore no longer needs to be asked. The Question Carousel 510 also includes a new qref added to the bottom of the list: howManyEmployees. This qref has been added because an answer of yes for anyEmployees 508 begs the question of howManyEmployees. This can be seen in the anyEmployees qref 508 qBegged property: “true: qCarousel: howManyEmployees”.

In addition, the Schedules Carousel 512 also has been amended to include the schedule employeePayrolls. Once it is established that a business does have employees, how much those employees are paid is an important follow up question, therefore the qref anyEmployees 508 begs the payroll schedule: “true: sCarousel: employeePayrolls”.

Continuing along the upper progression, even though howManyEmployees was added to Question Carousel 510, the next qref in the carousel remains anyConstruction, having been the second question in the initial Question Carousel 500 and now the first question after anyEmployees was removed. Because the anyConstruction qref is at the top of the list it is rendered to the user 518. If the user answers that yes there are construction operations, then the Question Carousel 520 will be further amended to add the qrefs typeOfConstruction and employeesWorkInTunnels. Both qrefs represent a deeper line of inquiry now that the construction risk has been confirmed.

Switching to the lower portion of the diagram, the progression is different if the user answers that they do not have employees. In this case, the Question Carousel 528 does not add any qrefs. It still removes anyEmployees (because the qref was already asked), but it also removes the qref haveRetirementPlan. This is removed because employee retirement plans are moot if there are no employees to ever retire, and the instructions to remove it are shown in the qref anyEmployees 508 in gBegged: “false: qCarousel: remove: haveRetirementPlans”. In this lower progression, the Schedule Carousel 530 and Coverage Carousels 532 remain unchanged, but the Nonsense Carousel 534 has several new additions. These represent qrefs, schedules and coverages that would only be relevant to users that have employees but make no sense to investigate if there are no employees. The qref howManyEmployees is self-evidently moot, but the qref regarding whether employeesWorkInTunnels merits further explanation. In the moment after anyEmployees 508 is answered, it is not yet certain whether employeesWorkInTunnels will be begged later in the process or not. Qref employeesWorkInTunnels is begged by the anyConstruction qref 536, which hasn't been asked yet. However, by adding employeesWorkInTunnels to the Nonsense Carousel 534 after a no answer to anyEmployees 508 we acknowledge that whether employeesWorkInTunnels is a moot point if there are no employees.

That is important to clarify. The lower progression continues on to show the qref anyConstruction 536 because it was listed in the initial Question Carousel 500. When the user answers yes to anyConstruction (perhaps they construct buildings using only use third-party contractors instead of employees), the qBegged property of anyConstruction 536 instructs the system to add the qref employeesWorkInTunnels to the Question Carousel 538. But, because employeesWorkInTunnels was placed on the Nonsense Carousel earlier 534, that qref is NOT added to the Question Carousel 538. The qref typesOfConstruction, which is begged by a yes answer to anyConstruction 536, DOES continue through to the Question Carousel 538. If answering typesOfConstruction does not beg any further qrefs then the Question Carousel 538 will become empty, and the system 10 in FIG. 1a will begin to resolve itself by moving on to the next stage (such as coverages or schedules) or summary/review and user signature collection. If typesOfConstruction happened to beg further qrefs they will be added to the Question Carousel (or other indicated carousels) and the organic line of inquiry would continue.

As a final observation, it is apparent to those skilled in the art that were the diagram FIG. 5a presented as a traditional decision tree (FIG. 5b) it would continue to branch at each question or decision, growing exponentially and becoming unwieldy the more questions were asked. In contrast, note that the anyConstruction qref 518 and 536 are exactly the same even though they arise in what would be different branches in a traditional decision tree. In short, the complexity of a decision model using the qrefs and carousels fundamental to this invention grows linearly based on the number of possible questions or conditionals instead of exponentially based on the number of questions or conditionals. Compared to traditional decision trees or commonly practiced machine learning techniques this reduces complexity, speeds calculation and evaluation, and dramatically increases the readability, and transparency of the decisions reached by the model.

### FIG. 6: DualColumns Primary Screen

FIG. 6 depicts two example user interface screens of the DualColumns type and how they change as questions are answered and the Question Carousel is amended. The upper part of the diagram shows the screen presented to the user with six questions shown 602. These questions correspond to the first six qrefs on the Question Carousel 600 and are created based on the qref information as described in the detailed description for FIG. 5a. DualColumns screens show questions in groups of six to speed up the data-gathering process, but in principle any set or subset of the Question Carousel 600 could be shown.

In this example, the user has answered yes to the anyEmployees question. After answering all the questions, the user clicks the Next button (lower right corner of box 602) to trigger the system to move forward. The system then refreshes the display with a new DualColumns screen 606. These questions correspond to the updated Question Carousel 604. In the same begging process described in FIG. 5a, the six qrefs already addressed from the Question Carousel 604 have been removed, leaving four of the original ten (yearFounded, website, feinNumber and subcontractorsUsed). Because the user answered yes to anyEmployees, anyEmployees then begs howManyEmployees, which is also added to the Question Carousel 604. The system then renders the new DualColumns screen 606 and because only five questions remain (less than six) all five are rendered on the screen.

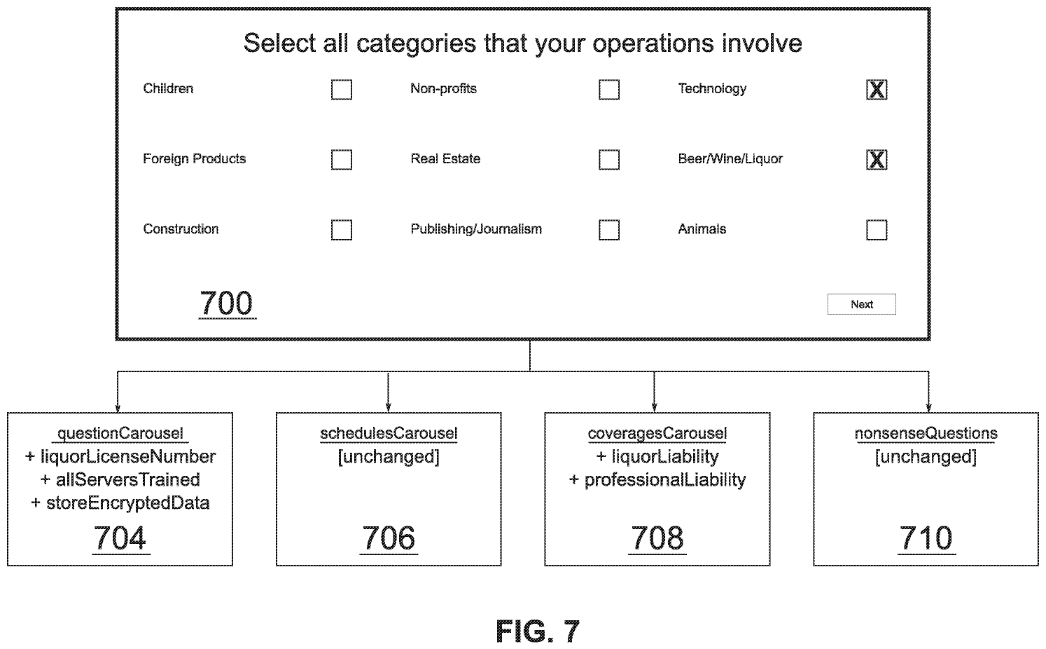

### FIG. 7: Red Flags

FIG. 7 shows an example of a Red Flag user interface screen 700. Red flags are activities, operations, characteristics or other properties that may impact a user or their operations which an experienced subject matter expert would identify as a trigger to pursue a more in-depth line of inquiry. In an insurance context, red flags would be activities that would likely cause an insurance company underwriter to desire additional information, and which may imply a higher risk than normal or more unusual type of risk. As respects other contexts noted earlier (medical diagnosis, legal analysis, compliance, and project management), red flags might be childhood diseases, states where a user has physical operations, types of regulated financial securities, or special functionalities required in a new building.

From a technical perspective, a Red Flag screen is simply a multiple-selection qref (redFlags). It is stored in the same data format as a normal qref, and is processed and begs additional qrefs, coverages and schedules in the same manner as other qrefs. Because redFlags can beg many otherwise unrelated qrefs and is a critical question, this example system happens to present it to the user on its own eye-catching screen.

In the example shown, the user answers that their operations involve both technology (such as software) and Beer/Wine/Liquor 700. Such a user might have a software company that throws lavish parties with an open bar for recruiting purposes, for example, and therefore be subject to the characteristic risks of both bars and software companies. When the user clicks the Next button the redFlags qref will flow through the begging process as described in FIG. 5a. How that begging would affect the four primary carousels is shown below the example screen. Because of the Beer/Wine/Liquor exposure the Question Carousel 704 would add qrefs related to liquor licensing and alcohol training required by state authorities, as well as proposing a specialized coverage related to alcohol sales called Liquor Liability to the Coverages Carousel 708. Because Technology was selected, the Question Carousel 704 also adds a qref about whether third party data is stored in an encrypted manner (as technology companies generally store third-party data). Technology also begs Professional Liability to be added on the Coverages Carousel 708, which is type of insurance coverage that can cover software failures or other professional errors but would not normally be purchased by a restaurant. The Schedules Carousel 706 and Nonsense Questions Carousel 710 remain unchanged.

Of note, Professional Liability on would likely have been begged on the Coverage Carousel 708 by a yes answer to Real Estate as well, as property management is a common responsibility of entities that are involved in real estate, and mismanagement of real properties is another risk that Professional Liability insurance can cover. In that case, however, the Question Carousel 704 would add questions such as the portion of commercial vs residential properties, or whether the property manager has part ownership of any of the properties. Begged qrefs and begging qrefs do not necessarily have a one-to-one relationship.

### FIG. 8: Coverage Selection

FIG. 8 shows the progression of the user being presented with coverages to choose from and how details about those coverages are addressed using primary and ancillary carousels. The leftmost diagram shows an example user interface screen for choosing coverages 800. The coverages presented are loaded based on the Coverage Carousel and will vary depending on the user's earlier answers. In this example based on an insurance context, General Liability and Directors & Officers are shown to all users because they can apply to all types of users. The Liquor Liability coverage would have been begged by an earlier qref, such as choosing Beer/Wine/Liquor on the Red Flags screen (FIG. 7), while the Auto coverage would be begged by a positive answer to a qref such as anyOwnedVehicles. When the user clicks on a coverage they are presented with a brief description of the coverage, and the option to either choose or reject it. To progress beyond this screen in the process, the user must actively choose or reject each coverage.

FIG. 8 shows the progression if the user clicks on the Auto coverage and chooses to accept it. Accepting the coverage begs the qref checkDriverRecords to see if the user checks driving safety records before hiring drivers as employees. This qref is added to the Question Carousel 806 (not the specific coverage carousel 802) because the answer to that question could have an impact beyond auto coverage. For example, driver safety records can impact the likelihood of an employee injury, which would involve Workers Compensation coverage, not just Auto coverage. Accepting Auto coverage also begs two schedules to be added to the Schedules Carousel 808: a list of drivers and a list of vehicles. Those schedules will include details like driver's license numbers, vehicle make, model and value, etc. The process of completing schedules, though similar to the coverages process, is addressed in FIG. 9.

In addition to the normal qref begging, when a user accepts a coverage the system transitions from the Coverage Selection 800 page to a Coverage Detail page 804. This screen works in a similar manner to DualColumns but shows only one qref at a time (rather than six). The Coverage Detail page 804 is NOT based on the Question Carousel 806, but instead on an ancillary carousel specific to the coverage, in this case the Auto Coverage Carousel 802.

The reason the Coverage Detail page is rendered based on the Auto Coverage Carousel 802 is because this page shows qrefs that apply ONLY to this specific coverage. In this example, a subject matter expert working with a client on Auto coverage would need to know the desired limit of insurance for Auto coverage (whatLimit), desired deductible (whatDeductible), and information on auto-specific subcoverages such as hired/non-owned auto (wantHNO) or personal injury protection (whatPipLimit). The whatLimit and whatDeductible qrefs will be repeated in other coverages, so it is important that answers be siloed and assigned to the proper coverage rather than affect the global scope. More universally applicable answers (such as checkDriverRecords) are begged to the Question Carousel 806 and are not siloed to the coverage.

Otherwise, the ancillary Coverage Carousel 802 is used the same way as the Question Carousel 806, and can have questions added, removed or labeled as Nonsense either from within the Coverage Detail page 804 process or from outside of it. For example, if the user selected yes to wantHNO, wantHNO might beg an additional question within the auto coverage ancillary carousel 802 clarifying whether the user wants HNO coverage to apply only to liability coverage, or whether they would also like it to include physical damage for rental vehicles (called hired vehicles in the context of insurance). Qrefs on the ancillary carousel 802 are cycled through one-by-one in the same way that the DualColumns page cycles through the Questions Carousel 806 in groups of six.

Once the user has either accepted or rejected all coverages, the system 10 in FIG. 1a progresses to the next phase, which in most instances will be returning to the DualColumns page to address any qrefs that were begged to the Questions carousel 806 in the course of selecting coverages.

### FIG. 9: Schedules Flow Diagram

FIG. 9 shows images of four example screens, as well as primary and ancillary carousels and one qref that impacts those screens. Schedules are similar to coverages but complicated by two primary differences. The first difference is that the user has the option to upload their own file to the system for most schedules and is required to do so in some cases. Because a schedule is simply a detailed list or collection of instances of a specific class (such as addresses, vehicles or drivers) it is very possible that the user already has a serviceable document which could be easily reviewed by a subject matter expert. These are simply uploaded to the database via the server (or local environment), and the meta data to identify the file stored for later retrieval. By use of traditional artificial intelligence or machine learning these uploaded documents can be analyzed, or simply provided to the subject matter expert for analysis. If a user does not upload a schedule or does not have the option to do so, the user must complete a walkthrough process similar to coverages.

The second major difference between coverages and schedules is that while coverages are singular, schedules frequently have more than one instance in the list (such as multiple drivers in a list of drivers), each with its own miniaturized line of inquiry. This necessitates two ancillary carousels—an initialization carousel for a specific type of schedule that is loaded at each new instance, as well as an in-Progress carousel that can be dynamically mutated as qrefs beg or remove questions related to the specific instance being investigated at the current moment.

This process is best explained via the example shown in the diagram of FIG. 9. Like the Coverages Cover page, the user is shown a list of relevant schedules 900 that is populated based on the Schedule Carousel (not pictured). All users see the locations schedule 918, but the drivers 920 and vehicles schedules 922 were likely begged by a yes answer to the anyOwnedAutos qref (not pictured) and by accepting Auto coverage 800. The user must complete each schedule by either uploading a file or by the walkthrough process in order to continue.

In this example the user elects to complete the locations schedule using the walkthrough process. Once that selection is made, the system loads an ancillary carousel specific to the locations schedule, called Schedule Carousel—Locations 902. This ancillary carousel 902 contains three qrefs related to information specific to a particular location: address, contents, and whether the user owns a building (vs leasing space) and therefore needs to insure the building itself (ownBuildingOrNot). These qrefs could have been included in the standard initialization (FIG. 4) or could have been qrefs that were begged by earlier questions, such as asking for buildingAge if an earlier answer suggested that the user has buildings built before a certain date.

In turn, the locations ancillary carousel 902 is used to populate a second ancillary carousel called in-Progress 906. The in-Progress Carousel 906 is the carousel that will actually be used to populate the Schedules Detail page 914 as shown in the bottom center of the diagram. The Schedules Detail page 914 will render each qref from the in-Progress Carousel 906 in order, starting with address, then contents, then ownBuildingOrNot. In this example, this example screen 914 shows the user answering that yes they do own the building.

The qBegged property for a yes answer to qref ownBuildingOrNot 912 states that the buildingValue qref should be begged. Therefore buildingValue is added to the in-Progress Carousel in its next phase 916. The first three qrefs are removed from the in-Progress carousel 916 because they have already been asked by this point, which means buildingValue qref is rendered on the subsequent Schedule Detail page 908. Not that buildingValue was ONLY added to the in-Progress carousel 916 and NOT added to the Schedule Carousel—Locations 902: we need to know the value of this building because we know it is owned by the user. That does not imply that we need to ask the value of every subsequent buildings because other buildings may or may not be owned.

In the next Schedule Details screen 908, the user enters the value of the building, but then clicks on the “Add next Location” button, indicating that they have completed entering information for their first location and that their operations include at least one more location. The system then initializes a second location within the location schedule (not pictured). Because this is a new location, totally separate from the first, the system must discard the in-Progress carousel 916 and start over again from the ancillary Schedule Carousel—Locations 902. Just like for the first location, the ancillary Schedule Carousel—Locations 902 (which was unaffected by any begging related to the first location) is used to populate the new in-Progress carousel for the second location 910, which is in turn used to render the next Schedules Detail page 904, which renders the first qref of the in-Progress Carousel 910. If the user does not own the building at the second location (indicated by a no answer when they are shown the ownBuildingOrNot qref) they will not be presented with the buildingValue qref again.

This process continues until the user finishes the last location, at which point they return to the Schedules Cover page 900 and begin the process again with the driver schedule 920 or the vehicles schedule 922. When all schedules have been addressed, the system progresses to the next stage, most likely DualColumns to address any qrefs added to the Question Carousel in the course of completing the schedules.

### FIG. 10: Derived Answer Process

After the data has been collected from the user it is processed to enhance the information provided, as well as convert it into any number of formats that are convenient for its ultimate use. In the insurance industry, this collection of data is called a submission. Before that conversion takes place, the submission is processed through a series of functions or rules to create derived answers. A derived answer is a statement or fact about the submission that can be deduced or inferred from other data within the submission. After calculation, the newly derived answer is added to the submission alongside data collected directly and can in turn be used to derive further answers and will be included in the final formatted data. The benefit of deriving answers is that the user does not have to answer as many questions, thereby improving their experience and requiring less of the user's time, as well as reducing the opportunity for inconsistent data.

The diagram in FIG. 10 shows a truncated submission 1000, which is stored in a standard hash table, Javascript® object or similar data structure. The submission is passed through a collection of derivative answer functions 1018. The first derivative function is onPremisesFoodRevenue 1008. In an insurance context, restaurants and similar operations are evaluated in part by what portion or amount of revenue is generated by food sold to customers at the location. On premises food sales are considered less risky in comparison to alcohol sales (which creates drunk driver risk) and catering sales (where the restaurant could cause damage to the home or venue being catered).

The onPremisesFoodRevenue derivative function 1008 pulls relevant data points from the submission data 1000: whether the operation is a restaurant, whether operations include catering, total expected annual revenue, the catering revenue, and revenue from alcohol sales. These answers, if present, are run through a simple decision flowchart, whereby the on premises food revenue is determined by simple subtraction of the applicable revenues: total sales, less alcohol sales and less catering sales if catering is present 1014. If the operation is not a restaurant then onPremisesFoodRevenue is not applicable and a blank answer (empty string) is returned 1010. This answer is then stored in the data hash for the submission alongside other answers 1020, and the updated submission is passed down to the next derivative function 1018, which is totalOwnedBuildingValue. The totalOwnedBuildingValue function would, in turn, loop through each location in the locations schedule, add up the buildingValue answers for each, and return the total.

Once all derivative answers are complete, the submission is ready for formatting and further use. Of note, derived answers can be calculated in real time as qrefs are being processed via various carousels, rather than after the submission is fully compiled.

### FIG. 11: PDF Forms Creation Process

FIG. 11 depicts the method by which the data in the submission is presented to a subject matter expert or other submission receiver in a traditional format that is useful for their purpose. In addition to the pdf or similar forms described in FIG. 11, the system may also produce a comprehensive spreadsheet that describes the entirety of the submission data in a reader-friendly format. In such case the methodology by which the formatting is accomplished is common in the software industry. The system may also produce data in a machine-readable format that can be used to interface directly with actuarial underwriting systems like such as CNA insurance's CNA Connect™ online rating platform or similar platforms; with Agency Management Systems like Applied Epic™, Applied TAM™, Vertafore Sagitta™, Vertafore AMS360™ or similar platforms; or any other automated decision-making platform or model.

For generating forms, the first step is determining which forms or pdf applications are appropriate given the data in the submission 1100. The appropriate forms were determined earlier in the process by use of a derivative function that analyzes the submission and produces a list of appropriate forms based primarily on coverages and red flags selected by the user, but also can incorporate other data points. In the example diagram shown in FIG. 11, the derived answer produced by the derivative function is shown as formsArray 1100. In this case the Liquor Liability pdf application and Auto coverage pdf application are appropriate and should be generated by the system.

Once the appropriate forms are identified, the system loads a formsMap specific to each application (1102 and 1104), as well as a blank application that may be formatted as an html file (1106 and 1108). For each application to be completed, the system loads the blank application file, and then cross-references the entire submission 1100 against the formsMaps (1102 and 1104). For each item of data that should be shown on the form, the formsMap identifies four pieces of information: the data in the submission that is relevant, the type of answer (which controls the way that the data is displayed), and horizontal and a vertical coordinates for where to place the answer on the form. In this way the data is connected to the form spatially, rather than requiring the system to understand the content of the underlying application. The system is effectively typing answers on a blank form in a digital approximation of an old typewriter. This allows the system to be extremely flexible if new applications need to be produced by the system, as it can ‘type over’ any existing application or image of an application. The formsMap can also be used by an automated decision-making system by simply disregarding the coordinates and using the structured data in whatever manner is appropriate, or by amending the formsMap with the name or memory address of the corresponding data field in the automated decision-making system.

Returning to forms, the Liquor formsMap 1102 indicates that the name of the company should be placed on the Liquor Liability application 100 pixels down from the top and 300 pixels from the left. The liquor license should also be text format and placed at 300 pixels down and 300 pixels over from the left. The signature (which may be stored in the submission as a base64 text string representing a graphical written signature) should be displayed in an image format and placed at the bottom of the page at 700 pixels from the top and 300 pixels over from the left. These placements are reflected visually in the representation of the pdf form 1106.

The Auto pdf application 1108 may be created in the same way as the liquor liability application 1104, and re-uses both the company name and the signature in the same locations as the Liquor Liability application 1104. However, it also includes two additional answers: wantHNO and wantPIP. Each of these have the xIfTrue type in the Auto formsMap 1104, which instructs the system to produce an X or checkmark if the answer in the submission is true, and nothing if false. This corresponds to a classic checkbox format common on many paper applications. In addition to these basic types, the system also may have several alternatives that correspond to norms common on traditional paper applications, including X if a schedule exists, currency formatting, and others.

After the blank form files have been modified to include the answers at the various coordinates, the file is simply converted to a pdf or similar format via a headless browser mechanism or transmitted to another automated decision-making system.

Various embodiments of the invention include implementations as a computer system programmed to execute the method or methods described herein, and as a computer program product. According to the computer system implementations, sets of instructions for executing the method or methods may be resident in the memory of one or more computer systems configured generally as described above. Until required by processing system (10 in FIG. 1a), the set of instructions may be stored as a computer program product in another computer memory, for example. Furthermore, the computer program product may also be stored at another computer and transmitted when desired to the user's workstation by a local area network or by an external communications network, such as the Internet or a wireless cellular network. One skilled in the art would appreciate that the physical storage of the sets of instructions physically changes the medium upon which it is stored so that the medium carries computer readable information. The change may be electrical, magnetic, chemical or some other physical change.

Although described in connection with an exemplary computing system environment, embodiments are operational with numerous other general purpose or special purpose computing system environments or configurations. The computer processing system environment is not intended to suggest any limitation as to the scope of use or functionality of any aspect. Moreover, the computing system environment should not be interpreted as having any dependency or requirement relating to any one or combination of components illustrated in the exemplary operating environment. Examples of well-known computing systems, environments, and/or configurations that may be suitable for use with aspects include, but are not limited to, personal computers, server computers, hand-held or laptop computing devices, multiprocessor systems, microprocessor-based systems, programmable consumer electronics, mobile telephones, network PCs, minicomputers, mainframe computers, distributed computing environments that include any of the above systems or devices, and the like.

Embodiments may be described in the general context of computer-executable instructions, such as program modules, executed by one or more computers or other devices. The computer-executable instructions may be organized into one or more computer-executable components or modules. Generally, program modules include, but are not limited to, routines, programs, objects, components, and data structures that perform particular tasks or implement particular abstract data types. Aspects may be implemented with any number and organization of such components or modules. For example, aspects are not limited to the specific computer-executable instructions or the specific components or modules illustrated in the figures and described herein. Other embodiments may include different computer-executable instructions or components having more or less functionality than illustrated and described herein. The order of execution or performance of the operations in embodiments illustrated and described herein is not essential, unless otherwise specified. That is, the operations may be performed in any order, unless otherwise specified, and embodiments may include additional or fewer operations than those disclosed herein. For example, it is contemplated that executing or performing a particular operation before, contemporaneously with, or after another operation is within the scope of aspects.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be given its broadest interpretation given the context in which that term is utilized.

When introducing elements of aspects or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements. Having described aspects in detail, it will be apparent that modifications and variations are possible without departing from the scope of aspects as defined in the appended claims. As various changes could be made in the above constructions, products, and methods without departing from the scope of aspects, it is intended that all matter contained in the above description and shown in the accompanying drawings shall be interpreted as illustrative and not in a limiting sense.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention.

What is claimed is:

1. A computer-implemented system to execute an organic line of inquiry or multi-step decision-making process. comprising:
a processor;
at least one memory connected to the processor, wherein the memory has stored thereon an application program for controlling the processor to implement a method of dynamically collecting and evaluating information in order to perform complex multi-step decision-making;
a database of one or more Question Reference Objects (Qrefs);
a database of one or more Carousels; and
at least one input/output device for entering user input or receiving other electronic input; and
wherein the processor is operative to execute instructions of the application program to implement the method of dynamically collecting and evaluation information in order to perform complex decision-making, wherein the method comprises:
accessing or receiving user input in the form of questions, prior answers, or other electronic input, such as from a sensor,
accessing Qrefs from the Qrefs database in response to the user input,
accessing Carousels from the Carousel database,
executing an organic line of inquiry by means of said Carousels and Qrefs for evaluating information, data or user input to answer the questions,
generating answers, and
outputting the answers or an appropriate decision based on the system input.

2. The computer-implemented system of claim 1, wherein the step of outputting the answers comprises:
outputting the answers to a user interface.

3. The computer-implemented system of claim 1, wherein the step of outputting the answers comprises:
outputting the answers to physical or electronic documents.

4. The computer-implemented system of claim 1, wherein the step of outputting the answers comprises:
transmitting the outputted answers over a communications link to an electronic decision-making system or document storage platform for further processing.

5. A system for evaluating the likelihood of an insurance loss arising from a person, organization, business or an asset or liability thereof, comprising:
a processor;
at least one memory connected to the processor, wherein the memory has stored thereon an application program for controlling the processor to implement a method of evaluating the likelihood of an insurance loss arising from a person, organization, business or an asset or liability thereof;
a database of one or more Question Reference Objects (Qrefs);
a database of one or more Carousels; and
at least one input/output device for entering user input or receiving other electronic input; and
wherein the processor is operative to execute instructions of the application program to implement the method of evaluating the likelihood of an insurance loss, wherein the method comprises:
initializing an organic line of inquiry based on meta data embedded within a protocol with information identifying a specific insurance agent, insurance carrier or other subject matter expert in insurance,
accessing or receiving user input in the form of questions, prior answers, and answers or in the form of other electronic input,
accessing Qrefs from the Qrefs database in response to the user input,
accessing Carousels from the Carousel database,
executing the organic line of inquiry by means of said Carousels and Qrefs for evaluating information, data or user inputs to answer the questions, and
generating answers, and
outputting the answers or an appropriate decision based on the answers,
wherein data gathered includes general data relating to the insurance risk, data regarding specific insurance coverages available, desired insurance coverage, data regarding collections of one or more instances of a specific class, such as addresses, vehicles or drivers on schedules, and supplemental data derived or inferred from the gathered data.

6. The computer-implemented system of claim 5, wherein the step of outputting the answers comprises:
formatting the answers into forms or spreadsheets; and
outputting the formatted answers to a user interface for evaluation in a traditional insurance underwriting method.

7. The computer-implemented system of claim 5, wherein the step of outputting the answers comprises:
formatting the answers into specific data structures for input into an automated underwriting process; and
outputting the formatted answers to the automated underwriting process.

8. The computer-implemented system of claim 5, wherein the step of outputting the answers comprises:
formatting the answers into specific data structures for input into an automated underwriting process; and
transmitting the formatted answers over a communications link to an actuarial underwriting system used by insurance carriers to evaluate and price risk.

9. The computer-implemented system of claim 5, wherein the step of outputting the answers comprises:
formatting the answers into specific data structures for input into an automated agency management system; and
transmitting the formatted answers over a communications link to the agency management system used by insurance agents to store and process exposure information.
